(19) United States
(12) Patent Application Publication
(10) Pub. No.: US 2016/0335049 A1
(43) Pub. Date: Nov. 17, 2016

(54) METHOD AND DEVICE FOR RESUMED PLAYBACK OF STREAMED MEDIA

(71) Applicant: SPOTIFY AB, Stockholm (SE)

(72) Inventors: KARL-JOHAN PERSSON, Stockholm (SE); STEVEN PAUL EVERINGTON, Stockholm (SE); FREDRIC VINNÅ, Stockholm (SE); STIG GUSTAV VIKTOR SÖDERSTRÖM, Ekero (SE)

(21) Appl. No.: 14/839,512

(22) Filed: Aug. 28, 2015

Related U.S. Application Data
(63) Continuation of application No. 14/714,161, filed on May 15, 2015.

(51) Int. Cl. G06F 3/16; H04L 29/08; H04L 29/06

(52) U.S. Cl. CPC G06F 3/165; H04L 65/60; H04L 67/147; H04L 65/1073

(57) ABSTRACT

This disclosure concerns the providing of media, and more particularly to the streaming of media. In accordance with an example embodiment, while receiving a first media content item of the streamed media content, a request for a second media content item is received, and a first data message sent to the computer server system, to return the second media content item. In response to receiving a second data message the electronic device begins to perform playback of the second media content item combined with the playback of the first media content item at the user interface of the electronic device, e.g. by pausing the first media content item. The electronic device receives a request for including the second media content item in a playlist associated with a current portion of the day, and includes the second media content item into the playlist associated with the current portion of the day.

### CLAIM OF PRIORITY

This application is a continuation of and claims priority to U.S. patent application Ser. No. 14/714,161, titled “METHOD AND DEVICE FOR RESUMED PLAYBACK OF STREAMED MEDIA”, filed May 15, 2015, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present disclosure generally relates to the providing of media, and more particularly to the streaming of media. In particular, the embodiments described herein relate to methods and electronic devices for performing playback of a media content stream and controlling a queue of subsequently playable media items in dependence of a time of a day.

### BACKGROUND

As computer technology has improved, the digital media industry has evolved greatly in recent years. Users are able to use electronic devices such as mobile communication devices (e.g., cellular telephones, smart phones, tablet computers, etc.) to consume music, video and other forms of media content. For instance, users can listen to audio content (e.g., music) and/or watch video content (e.g., movies, television (TV) broadcasts, etc.) on a variety of electronic devices.

At the same time, advances in network technology have increased the speed and reliability with which information can be transmitted over computer networks. It is therefore possible for users to stream media content over computer networks as needed, or on demand, rather than transmitting a complete file in physical media (such as CD or DVD, or downloading the entire file) before consuming the media content.

A user who uses an electronic device for performing playback of streamed media, requests media contents from a media server system. Typically, he/she inputs a title or an artist name at a user interface of the electronic device, and the electronic devices obtains the media content and performs playback of the media content at the user interface, e.g. by a speaker or display of the user interface.

### SUMMARY

It is in view of the above considerations and others that the various embodiments disclosed herein have been made.

It is a general object of the embodiments described herein to allow for an improved way of controlling playback of media, such as music or video, in dependence of the time of the day.

This general object has been addressed by the appended independent claims. Advantageous embodiments are defined in the appended dependent claims.

In a first of its aspects, this disclosure concerns a method performed by an electronic device for controlling the playback of streamed media content at a user interface of the electronic device in dependence of a time of a day. In the method, while receiving a first media content item of the streamed media content streamed from a computer server system and performing playback of the first media content item at the user interface, a request for a second media content item is received, and in response is a first data message sent to the computer server system. The first data message comprises instructions to the computer server system to return the second media content item. A second data message comprising the second media content item is received is received from the computer server system. In response to receiving the second data message the electronic device begins to perform playback of the second media content item combined with the playback of the first media content item at the user interface of the electronic device. The electronic device receives a request for including the second media content item in a playlist associated with a current portion of the day, and includes the second media content item into the playlist associated with the current portion of the day.

In some embodiments, the second data message may comprise image data, which is processed into an image associated with the second media content item, and the image may be displayed at the user interface.

In some embodiments, an interrupt-time, when the request for the second media content item is received, is registered. The interrupt-time may be utilized when later receiving a request for resumed playback of the first media content item at the user interface.

In some embodiments, the second media content may be included in the playlist at a first position.

In a second of its aspects, this disclosure concerns an electronic device for controlling the playback of streamed media content at a user interface of the electronic device in dependence of a time of a day. The electronic device comprises a user interface, a processor, and a memory storing computer program code. When the computer program code is run in the processor it causes the electronic device to, while receiving a first media content item of the streamed media content streamed from a computer server system and performing playback of the first media content item at the user interface, receive a request for a second media content item, and in response thereto send a first data message to the computer server system, the first data message comprising instructions to the computer server system to return the second media content item. Furthermore it causes the electronic device to receive a second data message from the computer server system, the second data message comprising the second media content item, and in response to receiving said second data message, begin to perform playback of the second media content item combined with the playback of the first media content item at the user interface of the electronic device. Moreover, the computer program code causes the electronic device to receive a request for including the second media content item in a playlist associated with a current portion of the day, and in response to receiving the request for including the second media content item, include the second media content item into the playlist associated with the current portion of the day.

As will be appreciated, the aforementioned media content stream may comprise audio content items such as songs, video content items such as a streamed video casts, or other media content items of appropriate forms of media content.

In some embodiments, the electronic device is a stationary electronic device, such as a stationary computer. In alternative embodiments, a portable electronic device, such as a portable media presentation device, a mobile telephone, a cellular telephone, a tablet computer, a laptop computer, or a personal digital assistant.

In a third of its aspects, this disclosure concerns a computer program, comprising instructions which, when executed on at least one processor, cause the at least one processor to carry out the method according to the earlier-described first aspect. A carrier comprising the computer program may also be provided. The carrier may for example be one of an electronic signal, an optical signal, a radio signal, or a computer readable storage medium.

Various embodiments described herein allow a user of an electronic device to automatically obtain media content which is associated with the current portion of the day. In some advantageous embodiments, the user is enabled to influence the playback when the user device performs playback. For instance, the user may be enabled to pause the current media content item, while taking part of another media content item and resume the playback of the first media content item later, from when it was interrupted. By registering an interrupt-time when the request for a second media content item is received, the electronic device is enabled to instruct a media server to temporarily stop, i.e. pause, streaming the first media content item, and resume the streaming later upon request. A user may switch between a plurality of media content items and resume paused media content items without loosing any part of the media content items. Thereby a more flexible process for taking part of streamed media content may be achieved for users.

### BRIEF DESCRIPTION OF THE DRAWINGS

These and other aspects, features and advantages will be apparent and elucidated from the following description of various embodiments, reference being made to the accompanying drawings, in which:

FIG. 1 is a block diagram schematically illustrating an exemplary media content delivery system in accordance with some embodiments;

FIGS. 2A-2D are schematic illustrations of a user interface in accordance with some embodiments;

FIGS. 3A-3D are schematic illustrations of a user interface in accordance with some embodiments;

FIG. 4 is a schematic flowchart of a method in accordance with an embodiment; and

FIG. 5 is a schematic view of a computer program, in accordance with an embodiment.

### DETAILED DESCRIPTION

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements or method steps throughout the description.

As described earlier, some existing solutions for playback of streamed media content may be inadequate. It is therefore a general object of the embodiments described herein to allow for an improved playback of streamed media content.

To address this, in accordance with an embodiment, described herein are a method and an electronic device for performing playback of a first media content item combined with a second media content item is provided.

When performing playback of a first media content item, and receiving a user input for a second media content item, the second media content item is obtained while the first media content item is paused. Thereby a user is enabled to pause a current playbacked media content item and return later.

Within this description, the term “Media content” will be used to denote any type of media content suitable for being playbacked on a speaker or a display of a user interface. For instance, media content may be realized in form of audio content, video contents, or image contents. “Media content items”, are items of these media content forms. For instance, a media content item may be a song, a video, an image. Furthermore, a media content item may comprise more than one form of media content, e.g. a music video comprises typically both a video part to be displayed at a user interface, and a corresponding audio part to be played at a speaker of the user interface.

Turning now to the figures, various exemplifying embodiments of the invention will be described in further detail.

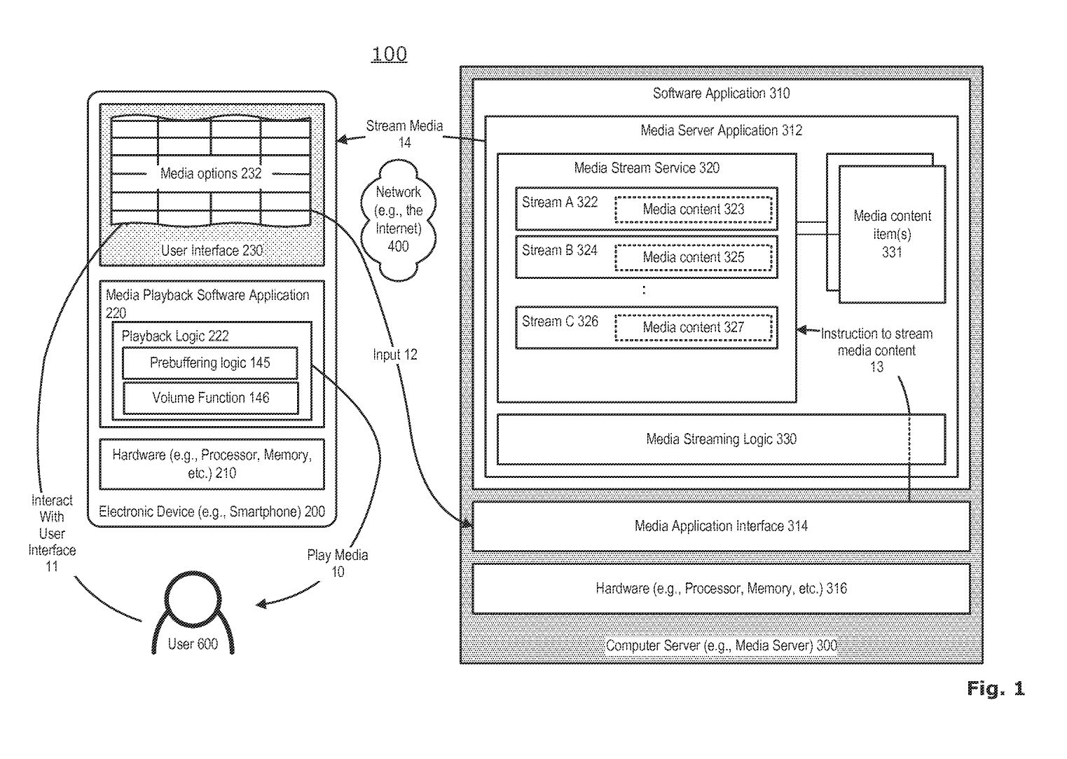

FIG. 1 illustrates a system 100 for playback of media content, in accordance with an example embodiment. The system 100 may comprise an electronic device 200 and a computer system 300 operating as a media server. The electronic device 200 may be communicatively connectable to the computer system 300 via a network 400, such as the Internet, as is conventional and known in the existing art. As can be seen in FIG. 1, only a single electronic device 200 and a single computer system 300 are shown. However, the computer system 300 may support the simultaneous use of multiple electronic devices, and/or the electronic device 200 can simultaneously access video content at multiple computer systems.

In the following description, the media content will be exemplified to be audio content so as not to obscure the description of the embodiments disclosed herein with unnecessary detail. This should, however, not be interpreted as limiting the scope of the various embodiments of the invention.

As shown in FIG. 1, the electronic device 200 may be used for the playback of audio content in dependence of a time or portion of a day, wherein the audio content is provided by the computer system 300. The electronic device 200 may be a mobile telephone, such as a smart phone. Alternatively, the electronic device 200 may be a tablet computer. In yet other embodiments, the electronic device 200 may be any other electronic device capable of playback of audio content complemented with lyrics content, such as, for example, one of the electronic devices of the following group: a computer, a laptop computer, and a mobile electronic device (e.g. a handheld entertainment device, a digital media player, or other media device).

The electronic device 200 may include one or several physical computer resources, or hardware resources 210. Likewise, the computer system 300 operating as a media server may include one or several physical computer resources, or hardware resources 316.

The computer system 300 may include an operating system or other processing system which supports execution of a software application 310, including a media server application 312 which may be used, for example, to stream audio content associated with a portion of a day. A media stream service 320 may be used to buffer media contents 323, 325, 327, e.g. audio content, video content, image content, etc., of appropriate media content items 331, for streaming to one or more media streams 322, 324, 326. A media application interface 314 may receive requests from electronic devices 200 or other systems, to retrieve media contents associated to an appropriate portion of the day from the computer system 300.

Media content or items 331 may be provided, for example, within a database or repository, or may be received by the computer system 300 from another source (not shown). This another source (not shown) may be external to the computer system 300, i.e. it may be located remotely from the computer system 300.

A media streaming logic 330 may be used to retrieve or otherwise access the media content items 331 in response to requests from electronic devices 200 or other systems, and populate the complemented stream service with streams 322, 324, 326 of appropriate media content items 331 that may be returned to the requesting electronic device 200.

In some embodiments, the electronic device 200 comprises a user interface 230. Typically, the user interface 230 includes a display 232, which is adapted to display lyrics information and a speaker (not shown) which is adapted to play the audio content. The display 232 is preferably, though not necessarily, a touch-sensitive display that is adapted to detect or otherwise determine a user input.

Selecting lyrics to be displayed at the display 232 may be used, or otherwise interpreted, as a request or instruction to the media server application 312 to stream or otherwise return associated media content which is being playbacked. For example, in accordance with some embodiments, the software application 310 at the computer system 300 may be used to stream or otherwise communicate associated media content to the electronic device 200, wherein the display 232 of said user interface 230 at the electronic device 200 is adapted to display an image which is associated to a song when playing the audio content at the speaker of the electronic device 200.

A user 600 may interact 11 with the user interface 230 and issue requests, for example the playing an associated song (audio content) or displaying an associated lyrics on the electronic device 200. The user's manual selection of day portion may be communicated 12 to the media server application 312, via the media application interface 314. The media server application 312 may then be instructed 13 to stream associated media content, including one or more streams of media content items 331, and subsequently stream 14 or otherwise communicate to the user's electronic device 200. In accordance with some embodiments, pre-buffering requests from the electronic device 200 may also be communicated to the media server application 312 via the media application interface 314. At the electronic device 200, in response to the user's interaction with the user interface 230, the media playback application 220, including the playback logic 222, may playback 10 the requested media content to the user 600, for example by playing back a song on the electronic device 200, as described in further detail below.

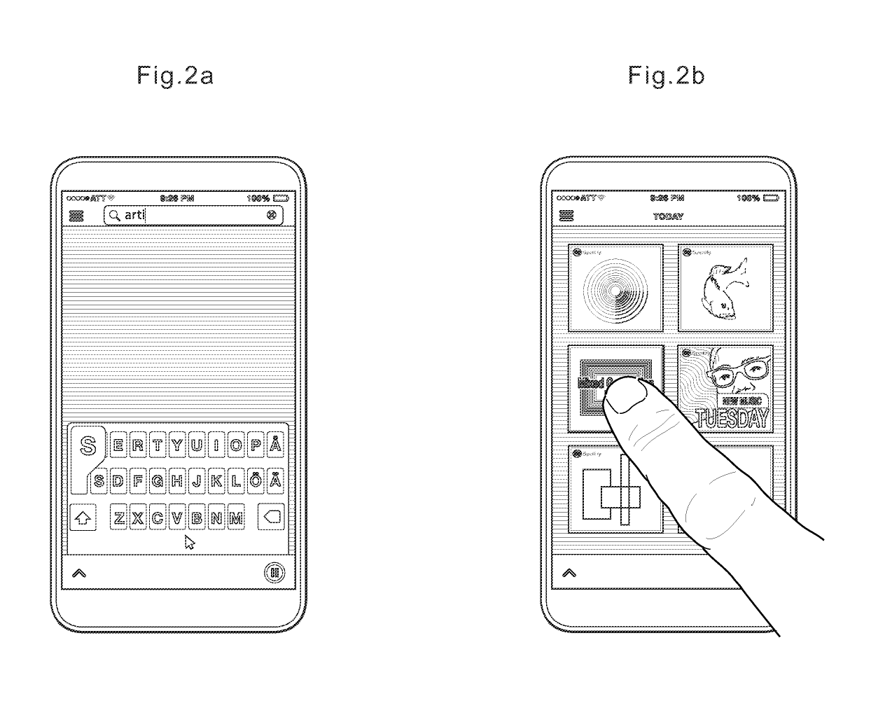

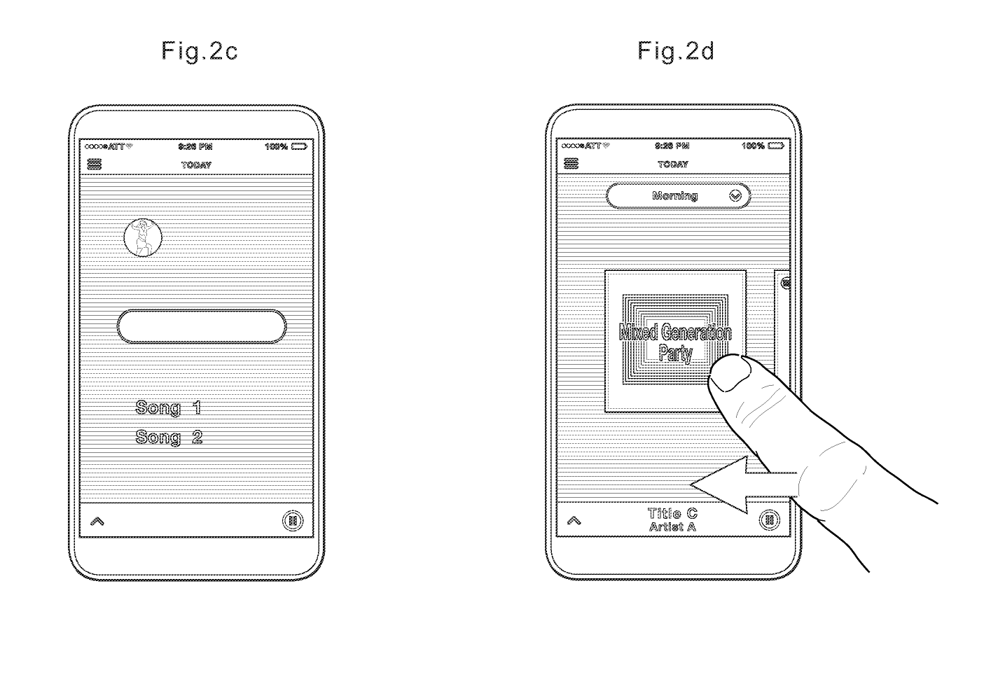

With reference to the FIGS. 2A-2D, which are schematic overviews, a user interface of an electronic device will now be described in accordance with some exemplifying embodiments.

In the FIGS. 2A-2D the user interface of the electronic device is illustrated. In this embodiment, the user interface is configured to perform playback of streamed media content in dependence of portions of a day, i.e. playback of a sequence of media content items. The functionality of performing playback in dependence of portions of the day is disclosed in the co-filed U.S. patent application Ser. No. 14/714,157, filed on May 15, 2015, entitled “PLAYBACK OF MEDIA STREAMS IN DEPENDENCE OF A TIME OF A DAY”, inventors Karl-Johan Persson et al, which is incorporated herein by reference.

When performing playback of streamed media content in dependence of a day portion, the electronic device comprises a user interface which determines a portion of the day, requests media content which is associated with the determined portion of the day from a computer server system, such as a media server. In response, the electronic device receives media content is associated with the current portion of the day, performs playback of the received media content item at the user interface, and adjusts a visual appearance parameter of the user interface according to the portion of the day. For instance, the user interface adjusts the visual appearance parameter by displaying a symbol or a color representing the portion of the day, or adjusts a brightness level of the user interface.

Even if the user is automatically served with media content items which are associated with the current portion of the day, the user may want to search for a specific media content item during the performed playback. The FIGS. 2A-2D illustrate some examples of searching for specific media content items.

In FIG. 2A, a search box and a keyboard are displayed at a display of the user interface. Typically, the display comprises a touch-sensitive surface, e.g. a touchscreen, at which the keyboard is displayed.

The user inputs a title of a media content item, an artist name, an album name, etc. by typing the title or name at the keyboard. In the FIG. 2a, this is illustrated as pressing the key “s” to type “artist” in the search box.

In FIG. 2B, a plurality of icons or symbols associated with selectable media content items are displayed at the user interface of the electronic device. In the FIG. 2B, each of the media content item is illustrated as a square with an icon or a symbol. The media content items in this embodiment are: podcasts, playlists of audio of video contents, web radio channels or stations, video-casts, etc., without being limited to these mentioned examples. The user selects one of the selectable media content items by pressing the corresponding icon or symbol with the finger, i.e. the user performs a user input at the user interface. Typically, the user interface displays symbols or icons of media content items which are adapted to the individual users, e.g. adapted to the users' age category, latest selected media content items, etc.

In FIG. 2C, titles of a number of selectable songs (“Song 1”, “Song 2”) of a preferred artist are displayed to the user at the user interface. A song is an audio content, and the user will select one of the selectable songs by performing a user input at the title of the wanted song. Typically, the user input is a pressing gesture at one of the song titles, but may alternatively be a tapping gesture, etc. Furthermore, further information or user controls may be displayed at the user interface. In the FIG. 2C, an image of the artist is displayed and a further user control is illustrated as a white bar. The bar may represent shuffle play, which is an alternative method of selecting a song to play. By pressing the bar, the user selects to play the songs in a random order.

In FIG. 2D, an icon associated with a currently playbacked media content item is displayed in the middle of a display of the user interface. In this embodiment the currently playbacked media content item is illustrated as the podcast “Mixed Generation Party” as an example. At the right border of the display another media content item to be playbacked is indicated as a part of another icon. The user selects to immediately perform playback of this indicated media content item by swiping the indicated icon into the middle of the display and replacing the icon of the currently played media content item, which is illustrated as fingertip that performs a swiping gesture at the display of the electronic device.

In the above described embodiments, the user has activated the respective search functions by pressing the menu symbol, i.e. the three horizontal lines in the upper left corner of the user interface with a finger. However, a skilled person understands that the activations may be performed alternatively when designing the user interface, e.g. by pressing a physical button (not shown) at the electronic device.

The streamed media content is received as media content items from a computer server system, e.g. a media server, and the above described user inputs for selecting a media content item to be playbacked are examples of requests for the second media content items.

Thus, while receiving a first media content item of streamed media content and performing playback of the first media content, the electronic device will receive a request for a second media content item. The electronic device will send a data message to the media server which comprises instructions to the media server to return the requested second media content item. The electronic device will then in response receive another data message from the media server which comprises the requested second media content item. This second media content item will then be playbacked at the user interface instead of the first media content item.

The user will be enabled to return to the first media content item by selecting the first media content item at the user interface. Correspondingly, he/she then performs the above described procedure, but selects the first media content item instead of the second media content item. As will be further described below in another embodiment, when returning to the first media content, the user will be enabled to proceed the playback of the first media content item from the time when it was paused, i.e. resuming the playback of the first media content item.

As described in the co-filed U.S. patent application Ser. No. 14/714,157, filed on May 15, 2015, entitled “PLAYBACK OF MEDIA STREAMS IN DEPENDENCE OF A TIME OF A DAY”, inventors Karl-Johan Persson, et al, when performing playback of streamed media content at the user interface of the electronic device in dependence of at time of the day, a visual appearance parameter is adjusted at the user interface to provide the user with knowledge of the current portion of the day. The user is served with a media content which is adapted to the user preferences, and the current portion of the day.

However, when the user wants to perform playback of a manually selected specific media content item and has selected that specific media content item as described above, the selected media content item will be placed first in a queue of media content items to be playbacked.

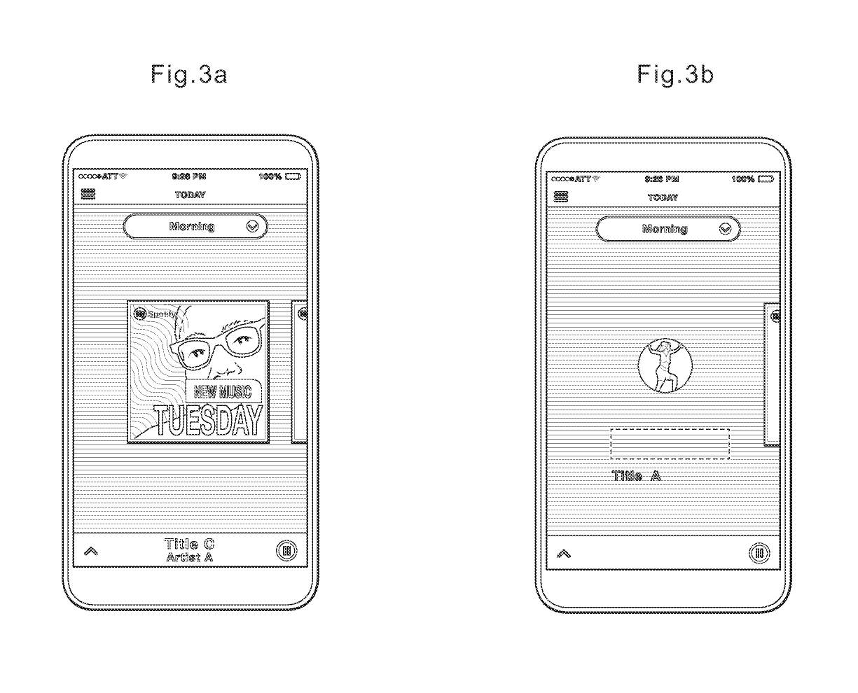

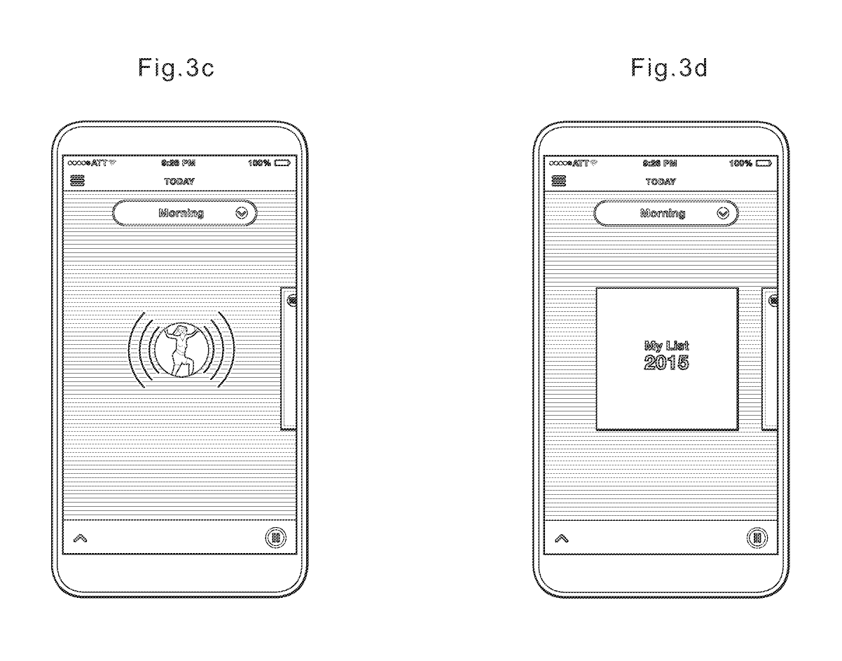

With reference to the FIGS. 3A-3D, which are schematic overviews, a user interface of an electronic device will now be described in accordance with some exemplifying embodiments.

The FIGS. 3A-3D illustrate four examples of placing the manually selected media content item a queue of media content items at the user interface.

In FIG. 3A, the current portion of the day is “Morning”. The user has manually selected the media content item “New Music Tuesday”, which is a selectable podcast, from the media server. As seen the selected podcast is inserted first in the queue and the currently playing media content item is interrupted and placed after the manually selected media content item in the queue. The interrupted currently playbacked media content item could be returned to by performing a swiping gesture at the user interface, i.e. swiping the interrupted and postponed media content item to the left at the user interface. This request for the interrupted and postponed media content item is a user input and will resume the playback of the interrupted media content item from the time when it was interrupted.

By registering the time when the swiping gesture was performed, i.e. the interrupt-time, the user will be enabled to switch back and forth between the originally playbacked media content item and the manually selected one, which will be further described below in another embodiment.

Furthermore, as illustrated in the FIG. 3A, the user interface may display further information related to the manually selected media content item, such as titles, artist names, etc.

In the FIG. 3B, a situation similar to the situation of the FIG. 3A is illustrated. However, the manually selected media content item is a song (“Title A”) instead of a podcast. The song has been manually selected in accordance with any of the embodiments described in conjunction with FIG. 2A or 2C. Further information of the song or artist may also be displayed at the user interface (illustrated as a dashed rectangle).

In the FIGS. 3C and 3D, two other situations similar to the situation of the FIG. 3A is illustrated. The situation in FIG. 3C differs in that the manually selected media content item is a podradio station instead of a podcast. As a non-limiting example the podradio station may provide similar songs to a specific song, which the media server has put together. In FIG. 3D, the manually selected media content item is a playlist. As well the podradio station and the playlist have been selected in accordance with any of the embodiments in conjunction with FIG. 2A-2C. It is to be noted that even if the described exemplifying embodiments relates to audio content, e.g. songs, podcasts, etc, the skilled person understands that the disclosed concept is not limited to any specific form of media content. Alternatively, the above described principles may be applied for other suitable forms of media contents such as video content, image content, combinations of contents forms, etc.

### Method Embodiments

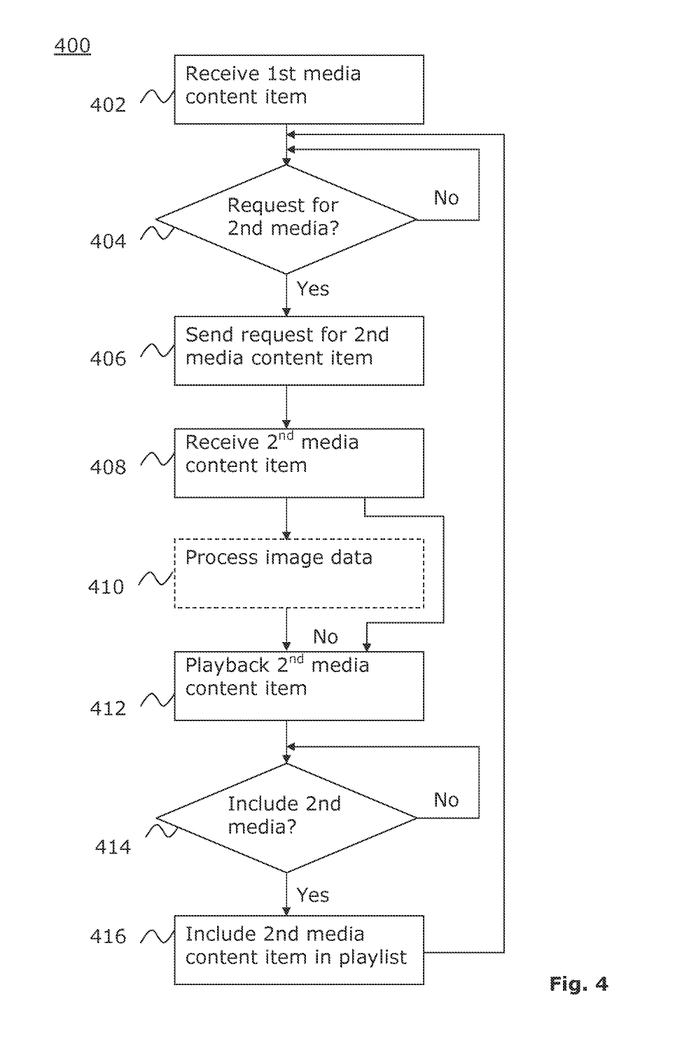

With reference to FIG. 4, which is a schematic flow chart, a method 400 of controlling playback of streamed media will now be described in accordance with one exemplifying embodiment.

The electronic device is arranged to perform playback of streamed media content at a user interface in dependence of a time of a day.

In a first action 402, the electronic device receives streamed a first media content item from a media server of a computer server system, and performs playback of the received first media content item at the user interface of the electronic device.

While receiving the first media content item, in another action 404, the electronic device receives a request for a second media content item. The request may be detected as a user input and comprise any of: a tap gesture, a swipe gesture, a click gesture, a textual input, a press gesture, etc. As illustrated in FIG. 4, the electronic device may monitor if the request is received or not.

In a following action 406, in response to the received request for a second media content item, the electronic device sends a first data message to the media server, where the first data message comprises instructions to the media server to return the requested second media content item.

In another action 408, the electronic device receives the requested second media content item from the media server according to the instructions sent to the media server.

The electronic device performs then, in a subsequent action 412, playback of the second media content item at the user interface of the electronic device combined with the first media content item. In one implementation of the method, the playback of the first and second media content items are combined, by pausing the first media content item while the second media content item is playbacked. However, playback combined of the first and second media content items may be alternatively performed within the disclosed concept. For instance, the media content items may be mixed together, or the first media content item may be faded out while the second media content item is faded in. Thereby a smooth transition may be achieved which is comfortable for the user.

In following action 414, the electronic device receives a request for including the second media content item into a displayed list of media content items to be playbacked. As indicated in the figure, the electronic device may perform a monitoring of user inputs in order to detect when such a request is received. The request may be performed as a user input in form of a tap gesture on a menu symbol, and a subsequent press gesture at a name of the user interface. For instance, when tapping at the menu symbol, the user interface displays a menu comprising some non-limiting examples of alternatives: “Search”, “Moments”, “User Interface”, “Music”, “Shows”, etc. The user presses at “User Interface” to include the second media content item into the displayed list.

In a final action 416, the electronic device includes the second media content item in the displayed list, e.g. before the first media content item as illustrated in any of the FIGS. 3A-3D. Alternatively, when including the second media item in the list, the currently first placed media content item may be replaced by the second media content item.

In a related exemplifying embodiment which is based on the above described one, the received second data message comprises image data of an image associated with the second media content item. For instance, the image may be an album cover, an image of an artist, or an image related to a radio station or a playlist, etc.

In an intermediate action 410, this image data is processed into the image, and the image is displayed in the displayed list in the action 416.

In a related exemplifying embodiment which is based on an above described embodiment, when pausing the first media content item, an interrupt-time, i.e. the time when the first media content item is temporarily stopped, is registered. Thereby, when the user wants to return to the first media content item, and performs a user input for the first media content item, i.e. a request for the first media content item, the registered interrupt-time may be included in a third data message by which the electronic device sends a request for the first media content item. This third data message corresponds to the above described first data message but is provided by the interrupt-time. The media server may then resume sending the first media content item from the interrupt-time in a fourth data message and pause sending the second media content item. Thereby, the user will be enabled to switch back and forth between media content items, and resume the paused media content items from when they were paused. The user will then be enabled to search for alternative media content items without loosing information of the currently playbacked one. For instance, if the user is listening to a podcast from a sports event, he/she will be enabled to take part of the daily news from another podcast without loosing information of the sports event. The user only has to switch back to the sports event from the news and resume the playback from the time when the sports event was paused.

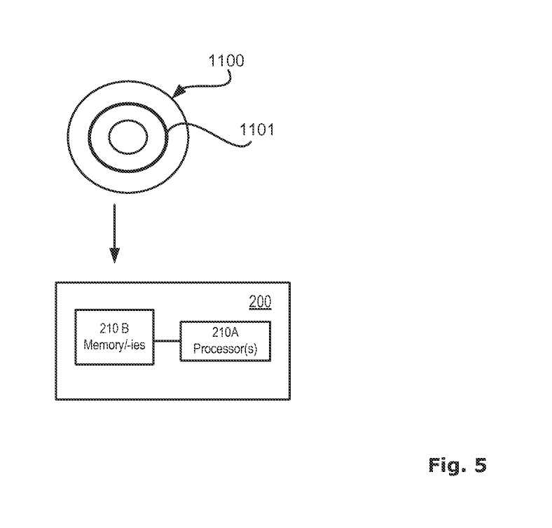

Turning now to FIG. 5, still another embodiment will be briefly discussed. FIG. 5 shows an example of a computer-readable medium, in this example in the form of a data disc 1100. In one embodiment the data disc 1100 is a magnetic data storage disc. The data disc 1100 is configured to carry instructions 1101 that can be loaded into a memory 210B of an electronic device 200. Upon execution of said instructions by a processor 210A of the electronic device 200, the electronic device 200 is caused to execute a method or procedure according to any one of the embodiments described in this disclosure. The data disc 1100 is arranged to be connected to or within and read by a reading device (not shown), for loading the instructions into the processor. One such example of a reading device in combination with one (or several) data disc(s) 1100 is a hard drive. It should be noted that the computer-readable medium can also be other mediums such as compact discs, digital video discs, flash memories or other memory technologies commonly used. In such an embodiment the data disc 1100 is one type of a tangible computer-readable medium. The instructions may alternatively be downloaded to a computer data reading device, such as an electronic device 200 capable of reading computer coded data on a computer-readable medium, by comprising the instructions in a computer-readable signal (not shown) which is transmitted via a wireless (or wired) interface (for example via the Internet) to the computer data reading device for loading the instructions into a processor 210A of the electronic device 200. In such an embodiment, the computer-readable signal is one type of a non-tangible computer-readable medium.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the described embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks may be provided through the use of hardware such as circuit hardware and/or hardware capable of executing software in the form of coded instructions stored on the above-mentioned computer readable medium. Thus, such functions and illustrated functional blocks are to be understood as being hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while certain gestures (e.g., hovering gestures, press gestures, and tap gestures) have been described to exemplify some embodiments, other conceivable gestures also exist (e.g. flick gestures, swipe gestures, swipe-and-hold gestures, release-of-hold gestures) that could be contemplated when reducing embodiments described herein into practice.

Furthermore, it should be appreciated that embodiments described in this disclosure could be advantageously combined with any one of the embodiments described in the co-filed U.S. patent application Ser. No. 14/714,157, filed on May 15, 2015, entitled “PLAYBACK OF MEDIA STREAMS IN DEPENDENCE OF A TIME OF A DAY”, inventors Karl-Johan Persson et al., which is incorporated herein by reference in its entirety.

Still further, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method performed by an electronic device for controlling the playback of streamed media content at the electronic device in dependence of a time of a day, the method comprising:
receiving, at an electronic device having a user interface, from a computer server system, a streamed media content in dependence of a time of day;
while receiving a first media content item of the streamed media content streamed from the computer server system, and performing playback of the first media content item,
receiving, at the user interface, a request for a second media content item, and in response thereto
causing an interrupt-time to be registered that indicates when the request for the second media content item was received,
sending a first data message to the computer server system, the first data message comprising instructions to the computer server system to return the second media content item, and
receiving a second data message from the computer server system, the second data message comprising the second media content item;
in response to receiving said second data message,
beginning to perform playback of the second media content item one of combined with or instead of the playback of the first media content item at the user interface of the electronic device, and
displaying at the user interface an indication of the first media content item that enables receipt of inputs to switch between playing of the first media content item and the second media content item;
receiving, at the user interface, a request for associating the second media content item with a playlist associated with a current portion of the day; and
in response to receiving the request for including associating the second media content item with a playlist associated with a current portion of the day, associating the second media content item with the playlist associated with the current portion of the day.

2. The method of claim 1, wherein the second data message comprises image data of an image associated with the second media content item,
and wherein the method further comprises processing the received image data to generate the image data into the image, and
and wherein performing playback of the second media content item comprises: playing the second media content item at a speaker of the user interface, and displaying the image at a display of the user interface.

3. The method according to claim 2, wherein processing the received image data comprises generating the image data into at least one of:
an image associated with an artist,
an image associated with an album,
an image associated with a playlist,
an image associated with a radio station.

4. The method of claim 1, wherein performing playback of the second media content item in combination with the playback of the first media content item comprises pausing the playback of the first media content item while performing the playback of the second media content item.

5. The method of claim 4, wherein pausing the playback of the first media content item comprises:
registering an interrupt-time when the request for the second media content item is received, and
including instructions, in the first data message, to pause sending the first media content item from the interrupt-time.

6. The method of claim 5, further comprising:
receiving a request for resumed playback of the first media content item,
sending a third data message comprising the interrupt-time to the computer server system, wherein the third data message comprises instructions to the computer server system to resume sending the first media content item starting from the interrupt-time,
receiving, from the computer server system, a fourth data message comprising the remaining portion of the first media content item starting from the interrupt-time, and
resume performing playback, at the electronic device, of the first media content item starting from the interrupt-time at the electronic device.

7. The method of claim 4, wherein pausing the playback of the first media content item comprises:
registering an interrupt-time when the request for a second media content item is received,
buffering the received first media content item, by means of a pre-buffering logic, from the interrupt-time, and
resuming the playback of the first media content item from the interrupt-time.

8. The method of claim 1, wherein including the second media content item into the playlist comprises placing the second media content item at a first position in the playlist.

9. The method of claim 8, wherein including the second media content item into the playlist comprises replacing the first media content item with the second media content item.

10. The method of claim 1, wherein receiving the request for a second media content item comprises detecting a user input, at an input unit of the user interface, in form at least one of: a tap gesture, a press gesture, a click gesture, a swipe gesture, or a textual input.

11. The method of claim 1, wherein receiving the request for including the second media content item in the playlist comprises detecting a user input, at an input unit of the user interface, in form at least one of: a tap gesture, a press gesture, a click gesture, a swipe gesture, or a textual input.

12. An electronic device for controlling the playback of streamed media content at the electronic device in dependence of a time of a day, the electronic device comprising:
a user interface;
a processor; and
a memory storing computer program code, which, when run in the processor causes the electronic device to:
receive, from a computer server system, a streamed media content in dependence of a time of day;
while receiving a first media content item of the streamed media content streamed from the computer server system, and performing playback of the first media content item,
receive, at the user interface, a request for a second media content item, and in response thereto
cause an interrupt-time to be registered that indicates when the request for the second media content item was received,
send a first data message to the computer server system, the first data message comprising instructions to the computer server system to return the second media content item, and
receive a second data message from the computer server system, the second data message comprising the second media content item;
in response to receiving said second data message,
begin to perform playback of the second media content item one of combined with or instead of the playback of the first media content item at the user interface of the electronic device, and
display at the user interface an indication of the first media content item that enables receipt of inputs to switch between playing of the first media content item and the second media content item;
receive, at the user interface, a request for associating the second media content item with a playlist associated with a current portion of the day; and
in response to receiving the request for associating the second media content item with a playlist associated with a current portion of the day, associate the second media content item with the playlist associated with the current portion of the day.

13. The electronic device of claim 12, wherein the second data message comprises image data of an image associated with the second media content item, and wherein the memory stores computer program code, which, when run in the processor causes the electronic device to
process the received image data to generate the image data into the image, and
perform playback of the second media content item by: playing the second media content item at a speaker of the user interface, and displaying the image at a display of the user interface.

14. The electronic device of claim 13, wherein the memory stores computer program code, which, when run in the processor causes the electronic device to generate the image data into at least one of:
an image associated with an artist,
an image associated with an album,
an image associated with a playlist,
an image associated with a radio station.

15. The electronic device of claim 12, wherein the memory stores computer program code, which, when run in the processor causes the electronic device to perform playback of the second media content item in combination with the playback of the first media content item by pausing the playback of the first media content item while performing the playback of the second media content item.

16. The electronic device of claim 15, wherein the memory stores computer program code, which, when run in the processor causes the electronic device to pause the playback of the first media content item by:
registering an interrupt-time when the request for the second media content item is received, and
including instructions, in the first data message, to pause sending the first media content item.

17. The electronic device of claim 16, wherein the memory stores computer program code, which, when run in the processor causes the electronic device to:
receive a request for resumed playback of the first media content item,
send a third data message comprising the interrupt-time to the computer server system, wherein the third data message comprises instructions to the computer server system to resume sending the first media content item starting from the interrupt-time,
receive, from the computer server system, a fourth data message comprising the remaining portion of the first media content item starting from the interrupt-time, and
resume performing playback, at the electronic device, of the first media content item starting from the interrupt-time at the electronic device.

18. The electronic device of claim 15, wherein the memory stores computer program code, which, when run in the processor causes the electronic device to:
register an interrupt-time when the request for the second media content item is received,
buffer the received first media content item, by means of a pre-buffering logic, from the interrupt-time, and
resume the playback of the first media content item from the interrupt-time.

19. The electronic device of claim 12, wherein the memory stores computer program code, which, when run in the processor causes the electronic device to include the second media content item into the playlist by placing the second media content item at a first position in the playlist.

20. The electronic device of claim 19, wherein the memory stores computer program code, which, when run in the processor causes the electronic device to include the second media content item into the playlist by replacing the first media content item with the second media content item.

21. The electronic device of claim 12, wherein the memory stores computer program code, which, when run in the processor causes the electronic device to receive the request for a second media content item by detecting a user input, at an input unit of the user interface, in form at least one of: a tap gesture, a press gesture, a click gesture, a swipe gesture, or a textual input.

22. The electronic device of claim 12, wherein the memory stores computer program code, which, when run in the processor causes the electronic device to receive the request for including the second media content item by detecting a user input, at an input unit of the user interface, in form at least one of: a tap gesture, a press gesture, a click gesture, a swipe gesture, or a textual input.

23. A non-transitory computer readable storage medium storing one or more instructions which, when executed on at least one processor, cause the at least one processor to carry out the method comprising:
receiving, at an electronic device having a user interface, from a computer server system, a streamed media content in dependence of a time of day;
while receiving a first media content item of the streamed media content streamed from the computer server system, and performing playback of the first media content item,
receiving, at the user interface, a request for a second media content item, and in response thereto
causing an interrupt-time to be registered that indicates when the request for the second media content item was received,
sending a first data message to the computer server system, the first data message comprising instructions to the computer server system to return the second media content item, and
receiving a second data message from the computer server system, the second data message comprising the second media content item;
in response to receiving said second data message,
beginning to perform playback of the second media content item one of combined with or instead of the playback of the first media content item at the user interface of the electronic device, and
displaying at the user interface an indication of the first media content item that enables receipt of inputs to switch between playing of the first media content item and the second media content item;
receiving, at the user interface, a request for associating the second media content item with a playlist associated with a current portion of the day; and
in response to receiving the request for associating the second media content item with a playlist associated with a current portion of the day, associating the second media content item with the playlist associated with the current portion of the day.
